(19) United States
(12) Patent Application Publication
(10) Pub. No.: US 2018/0237324 A1
(43) Pub. Date: Aug. 23, 2018

(54) MODULAR ALIGNMENT PROCESS SYSTEM FOR MOLD COMPONENTS

(71) Applicant: Keith Covert, Winchester, IN (US)

(72) Inventor: Keith Covert, Winchester, IN (US)

(21) Appl. No.: 15/895,859

(22) Filed: Feb. 13, 2018

Related U.S. Application Data
(60) Provisional application No. 62/458,142, filed on Feb. 13, 2017.

(51) Int. Cl. C03B 9/193; C03B 9/197

(52) U.S. Cl. CPC C03B 9/1934; C03B 9/342; C03B 9/197

(57) ABSTRACT

A mold system is provided for use in a glass container mold assembly that includes a base, a first plunger containing cylinder having a first cross-sectional area configured and sized to fit upon the base, and a male mold merger movable between a retracted and extended positioned that is configured tor insertion into a gob of molten glass to form an interior cavity in the gob to form a parison capable of be big blown into a glass container. The mold system comprises an alignment cylinder coaxially coupled to the plunger containing cylinder and having a second cross-sectional area larger than the first cross-sectional area of the plunger containing cylinder for accommodating and receiving a male mold member having a cross-sectional area too large to be accommodated by the first cross-sectional area of the plunger containing cylinder. The alignment cylinder includes an interior passageway.

### PRIORITY CLAIM

The instant application claims benefit to Keith Covert, U.S. Provisional Patent Application entitled MOLD COMPONENTS FOR USE IN MANUFACTURING GLASS CONTAINERS, Ser. No. 62/458,142, which was filed on 13 Feb. 2017, and which is fully incorporated herein.

### I. TECHNICAL FIELD OF THE INVENTION

The present invention relates to a device for use with the manufacturing of glass containers, and more particularly to mold components for use in making glass containers such as bottles and jars.

### II. BACKGROUND OF THE INVENTION

A large number of products are currently packaged in glass containers, including such products include pickles, mayonnaise, and beverages, such as beer. Glass containers are usually made in modern glass container factories that typically comprise three primary operation areas. These three operation areas include the “batch house,” the “hot end” and the “cold end.”

The batch house is the area of the operation that handles the raw materials, such as the sand, sodium oxide, calcium oxide and the like, from which the glass is made. The hot end handles the manufacturing of the glass container from the raw materials, and includes equipment such as furnaces, annealing ovens, and forming machines. The cold end area of the operation handles the product inspection and packaging equipment, and may also contain the filling stations wherein the filler material (e.g. beer, mayonnaise, pickles, etc.) is placed within the glass container.

The hot end of a glass works is the area of the plant where the molten glass is formed into empty glass containers. The first machine in the hot end of a glass works is usually a furnace and its feeder, wherein batches of raw materials are red into a furnace at a slow controlled rate. Often, these furnaces operate at temperatures of up to about 1575° C. and produce a stream of molten glass. This stream of molten glass that emerges from the furnace is then made into a glass container.

There are currently two primary methods of making a glass container from this stream of molten glass, including the “blow and blow” method and the “press and blow” method. In both cases, a cylindrical stream of molten glass at its plastic temperature (typically somewhere between 1050° C. and 1200° C.) is cut with a shearing blade to form a cylinder of glass This cylinder of glass is called a “gob”. The gob is then caused to fall by gravity and is guided by troughs and chutes into a blank “female” mold.

In the press and blow process with which the present invention is best employed, the solid gob of glass is converted into a parison having a hollow interior. A parison is a pre-container, and is generally somewhat cylindrically shaped, and does not yet include an exterior surface that mirrors the interior contours of the female mold that will give the container it its final shape.

The parison is formed in the press and blow process by the use of a metal plunger. The metal plunger is inserted axially into the gob to form a hollow interior cavity while pushing the glass out, and into the blank female mold. After the plunger is inserted into the interior of the gob (through what in the final bottle will be the open end of the bottle), the mold is flipped over. The glass is then blown out into the mold, through the introduction of compressed air into the parison's interior cavity that is farmed by the metal plunger. After the glass is blown out into its final form, it can then be cooled.

In a typical glass container factory, different types of containers are often manufactured on the same production line. This requires that plungers and molds be changed from time to time. Additionally, plungers are subject to wear out and breakage, thus requiring that they be replaced. Currently, replacing a plunger and/or a male mold member is a difficult and time-consuming operation. The difficulty of replacement is exacerbated by the fact that the plunger and mold member are usually very hot, thus leading to a risk of burns and discomfort to the person changing out the broken plunger. The time consuming nature of the process adversely economically impacts the container making operation since it requires that the mold with which the plunger is used go “off-line” during the plunger replacement process.

There are basically two mold stages that exist in the formation of a molded glass container. The first mold stage is the formation of the blank. The blank is the precursor bottle then blank essentially includes a formed neck and a body portion that looks like a test tube, that is generally cylindrical and extends for a certain length. The blank often will have a rounded, hemi-spherical bottom. It does not have the shape of the final bottle. After a blank is made the blank bottle then goes to a second stage. In the second stage, air is blown into the interior cavity of the parison to make the bottle Hue the interior wall of the female mold, winch gives the bottle its final shape.

In the manufacture of the blank, a gob of glass is placed into the female mold. A male mold member that is mounted on the distal end of an axially movable plunger then extends through the gob to create an axially extending cavity within the interior of the gob. The male mold member and plunger member are then retracted. After the male member is retracted one has the blank, which includes a formed neck, and a body portion in this generally test tube shaped. The interior of the body portion is generally somewhat hollow, as the hollow axial passageway having a blind end is formed by the insertion of the male mold member into the glass gob.

After the blank is moved to the second stage, air is blown into the cavity of the blank. Blowing air through the interior cavity of the blank forces the glass of the gob radially and axially outwardly and against the walls of the female bottle mold. As the female bottle mold comprises a “negative”, the glass that forms around the mold to form a positive glass bottle.

One of the difficulties that one faces in making molds, is accommodating glass containers of different sizes. In particular, the configuration of current machines and current cylinders places a limitation on the diameter of a container that can be made in conventional machines, and more particularly, on the diameter of the neck opening of bottles that can be made on conventional machines while using conventional cylinders.

In particular, the base to which a first stage mold cylinder is coupled has an area that essentially fixes and limits the diameter (width) of the first stage male mold member cylinder. Because of the fixed diameter, the diameter of the mate mold member defines the diameter of the neck opening of the container so formed. Therefore, the diameter of the neck opening of the bottle is limited in size by this fixed diameter of the machine.

This fixed diameter does not impact the ability of a manufacturer to produce containers having relatively small diameter openings, such as beer bottles, glass soft drink bottles, bar-b-que sauce bottles and the like. However, if does impact the ability of the manufacturer to make larger necked bottles having a greater opening diameter, such as pickle jars, mayonnaise jars, and the like. In particular, the size of the conventional cylinder employed today makes it difficult, if not impossible, for the manufacturer to switch between a small diameter male mold member, such as is used with a ketchup bottle, to a large diameter neck male mold member, such as would be used with a mayonnaise jar, without significantly dismantling the first stage male cylinder mold member.

Therefore, one object of the present invention is to provide a mate mold member cylinder that is adapted to handle both small diameter male mold members, such as are used for ketchup bottles, and larger male mold members, such as those that might be 90 mm. in diameter, and that are used in connection with larger diameter containers such as mayonnaise jars.

### III. SUMMARY OF THE INVENTION

In accordance with the present invention, a mold system is provided for use in a glass container mold assembly that includes a base, a first plunger containing cylinder having a first cross sectional area configured and sized to fit upon the base, and a male mold member movable between a retracted and extended positioned that is configured for insertion into a gob of molten glass to form an interior cavity in the gob to form a parison capable of being blown into a glass container. The mold system comprises as alignment cylinder coaxially coupled to the plunger containing cylinder and having a second cross-sectional area: larger than the first cross-sectional area of the plunger containing cylinder for accommodating and receiving a male mold member having a cross-sectional area too large to be accommodated by the first cross-sectional area of the plunger containing cylinder. The alignment cylinder includes an interior passageway.

In a preferred embodiment, the mold system also includes a sleeve member having an exterior surface and an interior surface. The exterior surface is sized and configured tor being received -within the interior passageway of the alignment cylinder. The interior surface defines an interior passageway sized for receiving the male mold member having a first cross-sectional area.

### BRIEF DESCRIPTION OF DRAWINGS

FIG. 1A is a perspective view of a first stage of a prior art male mold cylinder system, that includes a plunger cylinder 12 and an alignment cylinder 14;

FIG. 2A is a top view showing the interior of the plunger cylinder 12, and the inner air tube 36 contained therein for providing cooling air to the male mold member;

FIG. 3A is a perspective view showing a male mold member 32 that is useable with the mold system of the present invention, and generally has a relatively small diameter for forming a bottle having a small top opening, such as the beer bottle shown therewith;

FIG. 4A is a top view of the large modular alignment cylinder 16, in which is placed a lower guide member 26, and a wide mouthed (large diameter) male mold member 33 of the type used to create a wide mouthed jar such as a pickle or mayonnaise jar.

FIG. 4B is a top view of the large modular alignment cylinder of the present invention that includes a lower guide member 26 disposed therein, and that also shows the relative position of the air tube 36 that is disposed within the plunger cylinder 12.

FIG. 5A is an exploded view of the various components of the first stage mold member 10 of the present invention, including large modular alignment cylinders 16, a piston member 34, to which a wide mouthed male mold member 33 is coupled, a top alignment modular sleeve collar 18, an tipper modular alignment sleeve 22, a lower guide member 26, and a neck ring 38;

FIG. 5B is a top view of a large modular alignment cylinders 16, showing the lower radially inwardly extending flange thereof upon which a lower guide member 26 can rest;

FIG. 5C is a perspective view similar to FIG. 5C, of an assembled plunger cylinder 12 and large modular alignment cylinder 16:

FIG. 5D is a top view of a top alignment modular sleeve collar 18;

FIG. 5E is a top view of the upper modular alignment sleeve 22;

FIG. 6A is a partially assembled view showing components, including the plunger cylinder 12, to which is mounted a large modular alignment cylinder 16, which itself is contained within the bilateral alignment flange 30, that is used to properly position, and fixedly position a pair of the large module alignment cylinders 16;

FIG. 7A is a side, sectional view of the lower guide member 26 showing exemplary dimensions of a preferred embodiment;

FIG. 7B is a sectional view of the upper modular alignment sleeve 22 showing exemplary dimensions of a preferred embodiment;

FIG. 7C is a side, sectional view of the top alignment modular sleeve collar 18 showing exemplary dimensions of a preferred embodiment;

FIG. 7D is a side, sectional view of the upper modular alignment sleeve 22, being assembled and slidably received within the lower guide member 26;

FIG. 7E is a side, sectional view showing a pair of bases 40, upon which the cylinders are mounted it will be noted that the bases include a recessed (reduced thickness) area that serves as a platform for the bases, and that the width of the platform restricts the diameter of the cylinders that can be placed upon the base;

FIG. 8A is a perspective view showing a pair of bases 40. One of the bases has mounted thereon a pair of plunger cylinders 12, and a prior art alignment cylinder 14. In FIG. 8B the radial width of the cylinders 12, 14 is just slightly smaller than the width of the platform portion of the base, and as such, represents the maximum general radial width of a cylinder 12 that can be contained on the base. The size of the base 40 is governed by the size of the molding machine, and is relatively standardized;

FIG. 8B is a perspective, side view of the base 40 and plunger cylinder 1 2 and prior art alignment cylinder 14, shown in FIG. 8B;

FIG. 9A is a perspective view of a lower guide member 26, showing the radially outwardly extending base portion 180, and the axially distally facing shelf 184 thereof that serves as a lower spring seat for compression spring 28:

FIG. 9B is a top view of a large modular alignment cylinder 16, showing a lower guide member 26 inserted therein, so that the base of the lower guide member 26 rests upon the tipper surface of the radially inwardly extending base flange 126 of the large modular alignment cylinder 16;

FIG. 9C is a perspective view of the upper modular alignment sleeve 22;

FIG. 9D is a perspective view of an upper modular alignment sleeve 22 being interiorly received within the central passageway of the lower guide member 26, and illustrating the radially extending flange of the upper modular alignment sleeve 22 being aligned with the radially outwardly extending base flange of the lower guide member 26, to form the respective upper and lower spring seats for compression spring 28;

FIG. 10 is a top view of the upper modular alignment sleeve 22 and lower guide member 26, wherein a male mold member 32 is interiorly received within the interior, axially extending passageway of the upper modular alignment sleeve 22 and lower guide member 26;

FIG. 11A is an assembled view of the top alignment modular sleeve collar 18 that is coupled to the upper end of the upper modular alignment sleeve 22. The upper modular alignment sleeve 22 is slidably received within the lower guide member 26. A male mold member 33 is inserted within the interior passageway of the upper modular alignment sleeve 22 and lower guide member 26;

FIG. 11B is a top view of the neck ring 38;

FIG. 11C is a side view of the neck ring 38;

FIG. 11D is a side view of the upper modular alignment sleeve 22 and neck ring 38. The lower end of the ring 38 engages an upper lip member 218 of the upper modular alignment sleeve 22. The upper lip member 218 is beveled 230, so as to better receive a corresponding beveled surface formed on feet at the proximal end of the neck ring 38, so that the neck ring 38 can be properly aligned upon the upper end of the upper modular alignment sleeve 22;

FIG. 12 is a perspective view of a display table, showing that the large modular alignment cylinder 16 of the present invention can receive top alignment modular sleeve collars 18, upper modular sleeves 22 and lower guide members 26 that are configured to receive appropriate mold members having a variety of different diameters, such as a 90-mm diameter mold member, and a 68-mm diameter mold member.

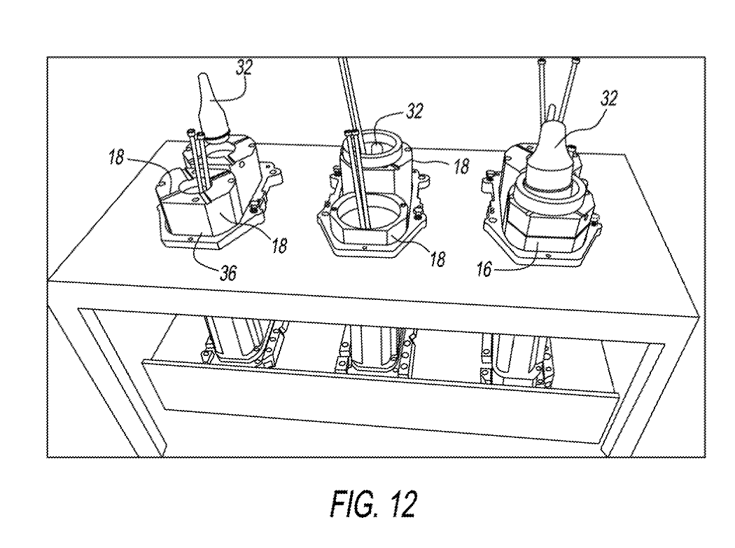

### V. DETAILED DESCRIPTION

The scope of the present invention is intended to cover ail such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing reference numbers, such as, for example, in eases where such labeling facilitates a clearer description. Additionally, the drawings set forth herein are not necessarily drawn to scale, and in some instances proportions may have been exaggerated to more clearly depict certain features. Such labeling and drawing practices do not necessarily implicate an underlying substantive purpose.

Further, certain views are side views which depict only one side of the vehicle (or one set of components of a multi set array of components), but it will be understood that the opposite side and other component sets are preferably identical thereto. The present specification is intended to be taken as a whole and interpreted, in accordance with the principles of the present invention as taught herein and understood by one of ordinary skill in the art.

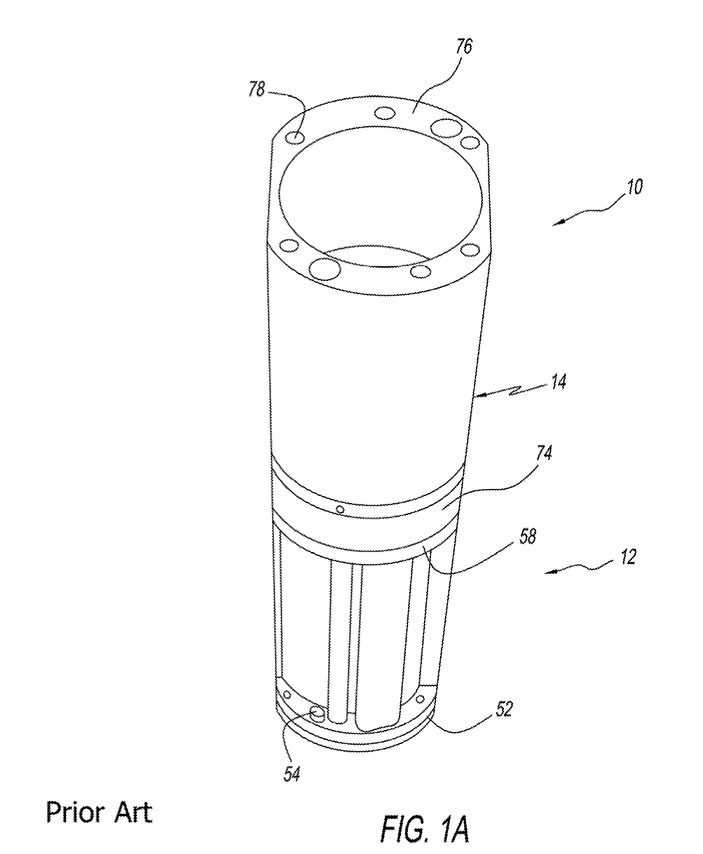

Turning first to FIGS. 1A, 2A, 3A, 8A, and 8B a prior art first stage mold system is shown that includes a lower plunger cylinder 12, and an upper, prior art alignment cylinder 14. It will be noted that the plunger cylinder 12 and alignment cylinder 14 have generally the same diameter.

The prior art lower plunger cylinder 12, is identical to the plunger cylinder 12 that is used in connection with the present invention. There is no reason to change the plunger cylinder 12, as it will perform its intended function with the present invention.

The size of the plunger cylinder 12, with regard to its height and width or diameter is fairly fixed by constraints imposed by the molding machine in which it is mounted, and the base 40 on which it rests. As will be described in more detail below, the present invention is designed to work around the constraints that are imposed by the standardized size of plunger cylinder 12.

The width or area of the plunger cylinder 12 is fixed by the constraints of the machine. It will be noted that the plunger cylinder has something of an ovaloid cylindrical shape, and is not circular, although its interior passageway 62 is generally cylindrical in configuration. As such, the term “diameter” will be used for convenience in the instant application, to relate to a term which might also be properly referred to as a “width.” In this regard, it will be noted that since the cross section of plunger cylinder 12 is not cylindrical, the “diameter” is not a constant diameter, but rather varied depending upon the plane in which the diameter line cuts through the cylinder. In this regard, the plunger cynlinder 12 is more closely related to an oval insofar that an oval has a short and a long diameter.

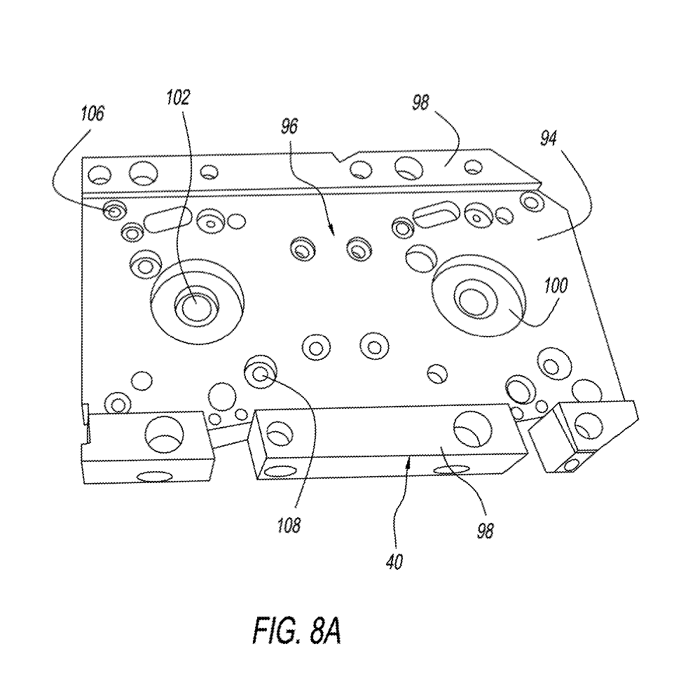

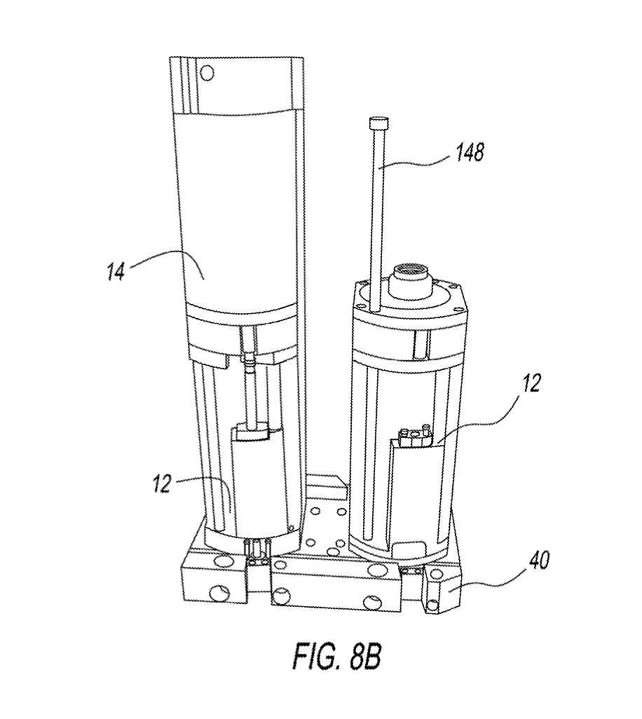

The plunger cylinder 12 includes a radially outwardly extending lower mounting flange 52 having a plurality of both receiving aperture 54 through which bolts can pass to secure the plunger cylinder 12 to the base 40 (FIG. 8a). The plunger cylinder 12 also includes a radially outwardly extending upper mounting flange 58 having a plurality of bolt receiving apertures (not shown), through which a bolt (not shown) can pass for coupling the plunger cylinder 12 to the alignment cylinder 14 (in the prior art), or a large modular alignment cylinder 16 of the present invention.

A generally cylindrical interior passageway 62, having a generally constant inner diameter extends between the proximal and distal ends of the plunger cylinder 12. An air vent tube 36 is disposed coaxially with the interior passageway 62 and is provided for conducting air from outside the plunger cylinder 12, to the interior of the male mold member 12, to help cool the male mold member 12. The air vent tube 36 includes a base 68, and an upper end 70.

The prior art alignment cylinder 14 includes a lower flange 74 and an upper surface 76. The lower flange 74 includes bolt receiving apertures for receiving bolts for coupling the prior art alignment cylinder 14 to the upper mating flange 58 of the lower plunger cylinder 12. The upper surface 76 of the prior art alignment cylinder 14 includes bolt receiving aperture 78, to which the proximal 78 can be coupled to collars or rings, as discussed in more detail below.

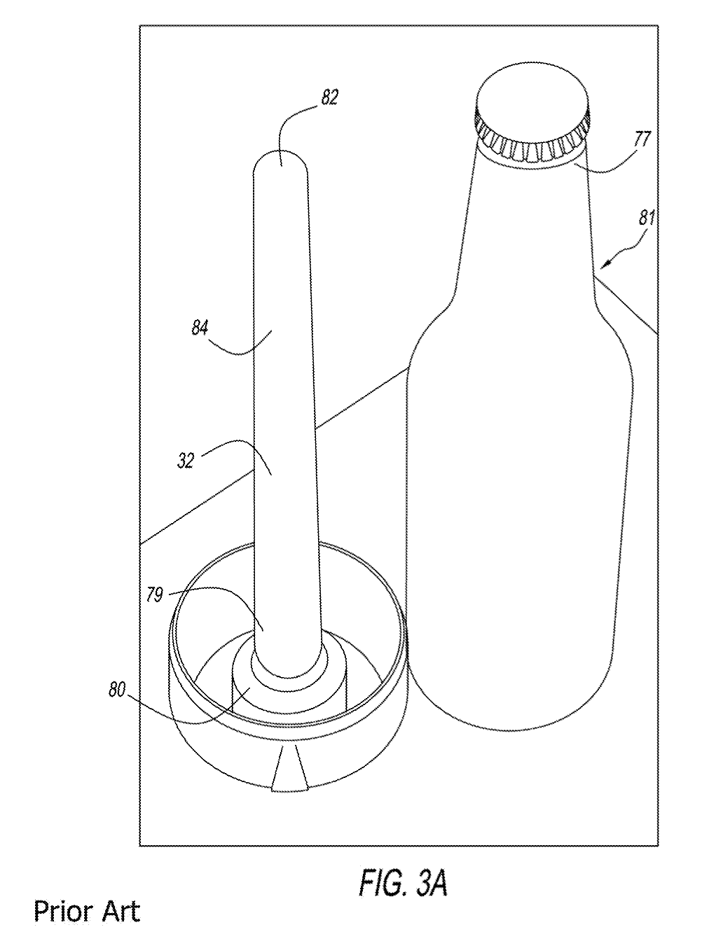

The male mold member 32 shown in FIG. 3A includes a proximal end 79 and a distal end 82. The proximal end 79 includes a radially outwardly extending flange 80 which, when in use, defines the axially facing upper surface of the parison to be formed by the mold member 32. The proximal end 79 is that of a first stage male mold member 32 which ultimately is placed adjacent to the bottle opening and of the bottle to be formed by the first stage male mold member 32.

A rounded distal end 82 is provided at the distal end of the male mold member 32. The distal end 82 is rounded, to help the male mold member better penetrate and pass through the gob of molten glass that is being molded by the first male mold member. A generally tapered conical shaft portion 84 extends between the distal end 82 and the proximal end 79. As with most mold members that need to be inserted into a female receiver, the diameter of the mold member adjacent to the proximal (lead) end 79 is greater than the diameter of the mold member near the distal end 82, to facilitate insertion into and removal from the female mold member.

The male mold member 32 shown in FIG. 3A is sized and shaped to form a bottle, such as beer bottle 81, that has a relatively small diameter opening 77.

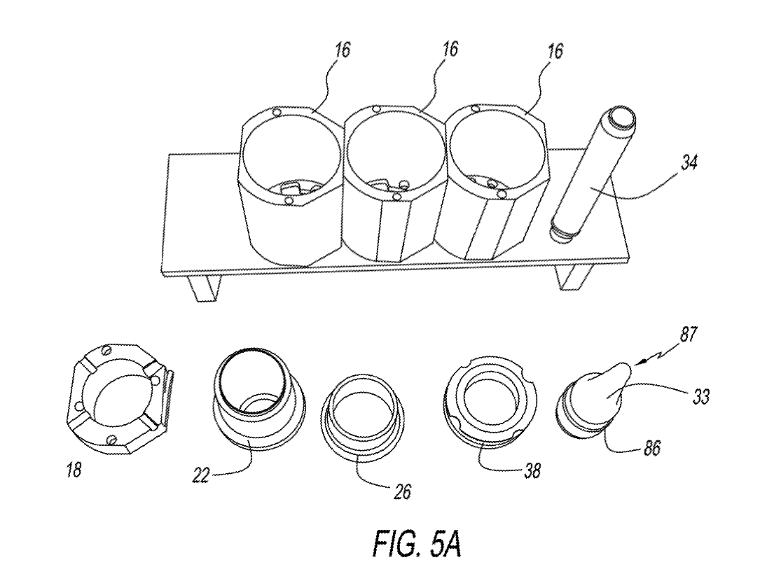

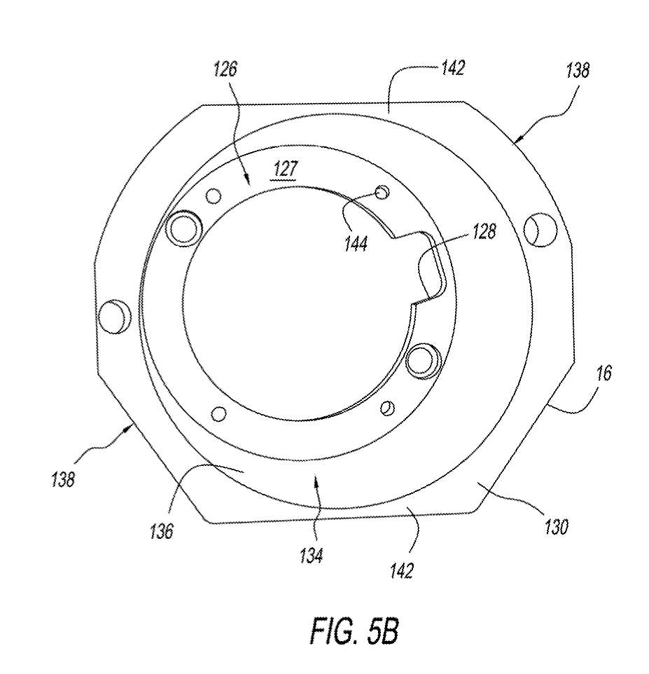

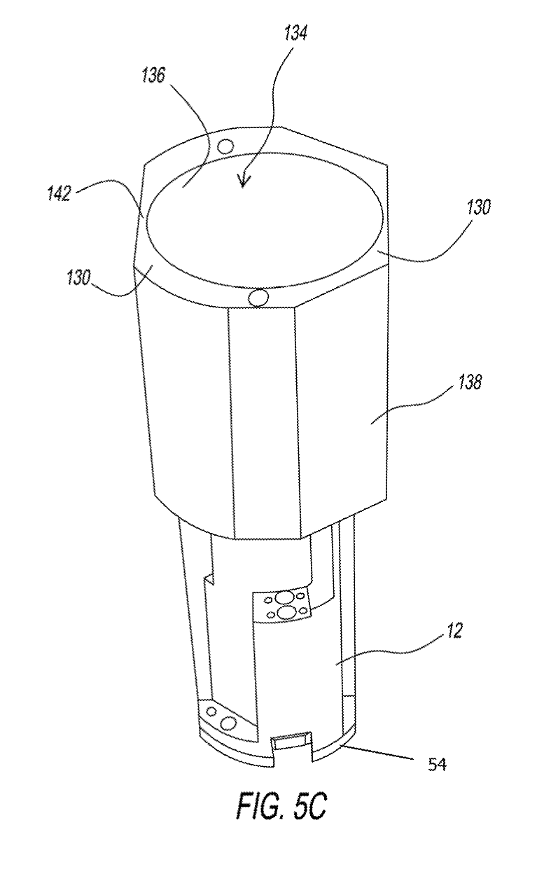

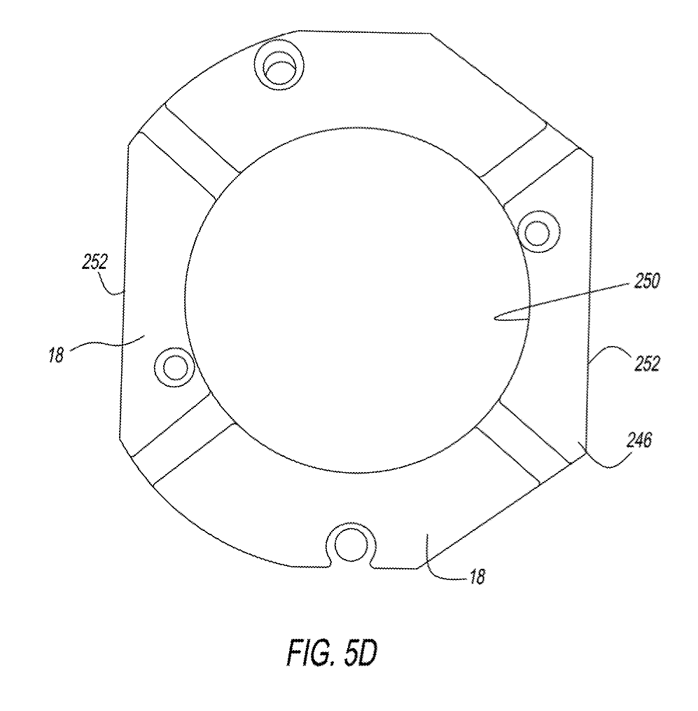

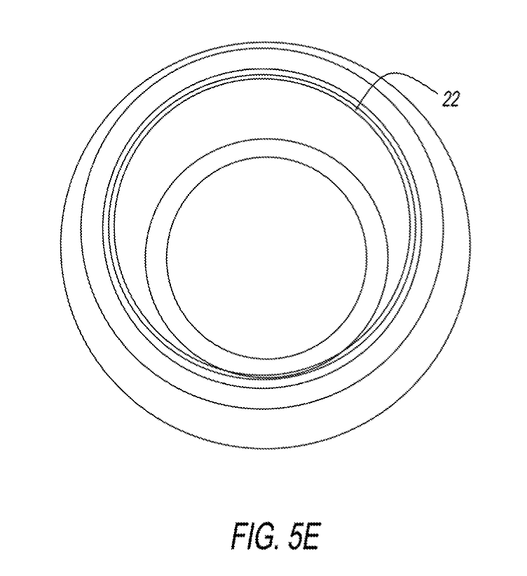

As is best shown in FIG. 5a, a wide-mouthed male mold 33 is shown. Wide-mouthed male mold member 33 has a generally enlarged diameter dome-shaped proximal portion 86, and a relatively reduced diameter tapered cone distal portion 87 having a rounded (hemispherical) distal end.

The wide-mouth male mold member 33 has the relatively wide proximal portion, to form a relatively larger diameter opening, such as one might use in a mayonnaise jar or a pickle jar. In contrast, the distal end has a relatively smaller diameter and u tapered cylindrical shape to help the distal end of the distal portion better penetrate through the gob of molten glass in the first stage of the molding process. The dome shaped proximal portion 86 helps to provide a smooth transition between the leading edge small diameter tapered cylinder of the distal portion 87, and the wide month of the proximal portion 86.

The base on which the plunger cylinder 12 is mounted is best shown at FIG. 8, as being generally plate-like in configuration, and having a lower surface (not shown) and an upper mounting surface 94, to which the plunger cylinder 12 fixedly coupled by bolts or the like.

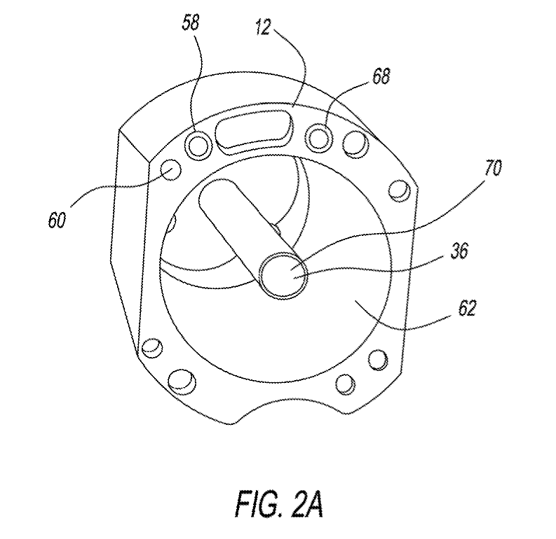

Along each of the edges are parallel extending raised thickened outer portions 98, which define a central reduced thickness recessed portion 96. The reduced thickness recessed portion 96 provides the plate or surface onto which the plunger cylinder 12 attached. There exists a further reduced generally circular air tube receiving portion 100 that includes a central aperture 102. The further recessed portion 100 is provided for receiving the air tube 70 (FIG. 2A) that is aligned with aperture 102 so that air may be passed into the interior of the male mold member 32, 33 to help keep it cool.

The base 40 also includes a plurality of bolt receiving apertures 106, to which the plunger member lower flange 12 can be coupled, and fluid ports 108, through which a fluid can be directed to the interior surface of the mold, to help cool the mold, to thereby help cool the glass within the mold, to hasten the solidification of the glass gob.

The similar diameter of the prior art alignment cylinder 14 and the plunger cylinder 12 is dictated largely by the size of the plunger cylinder 12. The diameter (width) of the plunger cylinder 12 is determined by tire size of the base 40, on which the plunger cylinder 12 must be mounted. The size of the base 40 is constrained by the machine size, and is generally constant with certain types of machines.

Therefore, because the size of the alignment cylinder 14 is constrained to a certain size, the size of a bottle that can be produced is similarly constrained, since the diameter of the neck of the bottle can be no larger than the effective diameter of the interior passageway of the plunger cylinder 12 and alignment cylinder 14. Often, the diameter of a male mold member 32 that can be inserted into the cylinder 14 is significantly smaller than the diameter within the inner diameter of the alignment cylinder 14, as some sort of mechanism is necessary to align the mold member within the cylinder, that reduces the effective diameter available to the mold member 32. Thus, the effective diameter of the alignment cylinder 14 is significantly smaller than its actual diameter.

Although these limitations on the size of the neck and opening 77 of the bottle 81 ultimately produced is not a problem when one is producing small neck, small neck bottles such as beer bottles 81, soft drink bottles, or low viscosity salad dressing bottles, it can be a problem with bigger necked or wide-mouthed glass container bottles.

For example, large-mouthed containers such as mayonnaise jars, pickle jars, and the like often require a larger neck, as a large necked container has a larger opening. Unfortunately, prior art cylinders 14 such as cylindrical alignment cylinder 14 shown in FIG. 1 are incapable of handling male mold members with larger necks, because the interior diameter of the receiving cylinder 14 is not large enough to receive a male mold member 32, 33 in a manner that enables the mold member 32, 33 to be aligned appropriately, so that the axially extending cavity within the gob that is formed by the mold member 32, 33 is formed appropriately.

The mold member 32, 33 should extend through the center of the neck ring 38 so that the neck of the bottle formed has a uniform thickness around its diameter. If the mold is not aligned, and is therefore “off center,” it is likely that one portion of the neck will be thicker than another portion of the neck. This thinness of the neck can cause a bottle to break which can result in a substantial product loss, and have profit reduction.

For example, if one were to place a 90 mm cylindrical male mold member 33 within the prior art alignment cylinder 14 as shown, significant problems would result. During the operation of the mold, when the formed blank is moving from the first stage to the second stage, a neck ring 38 is placed over the top of the alignment cylinder 14. The male mold member 32 is then extended through the neck member 38 so that the distal end 82 of the male mold 32 (or 33) forms the axially extending hollow inner cavity within the blank.

As the male mold member 32, 33 extends through the neck ring 38, it is important that the mold member 32, 33 extends through the center of the neck ring 38, so that the thickness of the neck portion of the parison is uniform about its diameter.

Unfortunately, current equipment does not permit this, because there is some play within the equipment, as the various mold components come together and pull apart during a normal molding cycle. Because of this play, it is likely that the mold member 32 will have the ability to “wiggle into position” within the neck member in a manner so that it was not perfectly aligned in the center of the neck.

If the male mold member 32 is not aligned within the center of the neck ring 38, then this mis-alignment wall cause a portion of the neck wall formed by the male mold member 32 or 33 in the gob to be thinner than other portions of the wall. Both the “too thick” and “too thin” defects can negatively impact the potential performance of the glass container. For example, if the wall of the neck of the bottle is very thin, excessive bottle breakage will result, which results in loss of production time, and product if the bottle is full of product such as pickles or mayonnaise.

Another challenge faced by the manufacturer is to be able to reduce the amount of time spent and difficulty encountered when switching out mold components, so that one can remove a first mold made of a fixed size and replace it with a second mold member of a second size to switch the manufacturer of a first bottle having a first size and shape to a second bottle having a second size and shape.

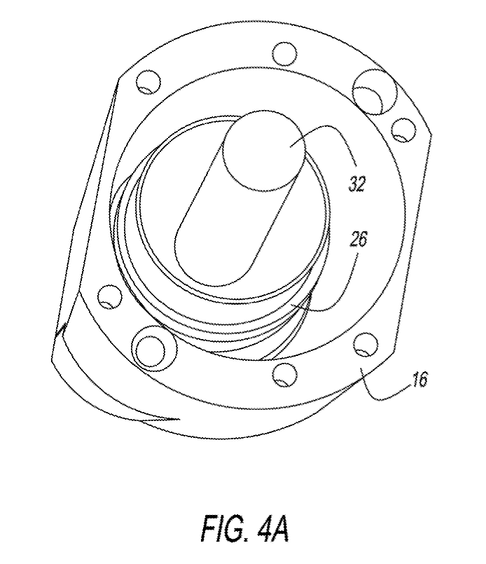

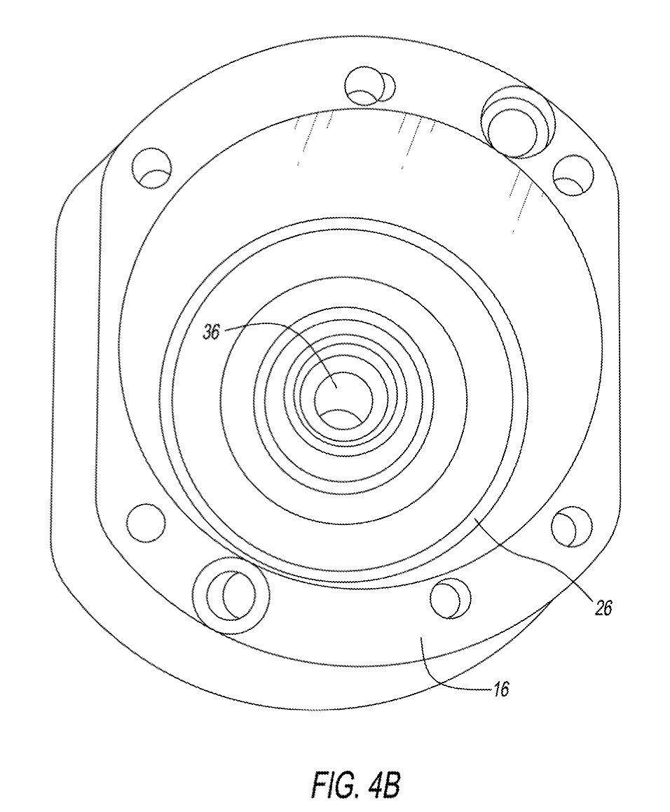

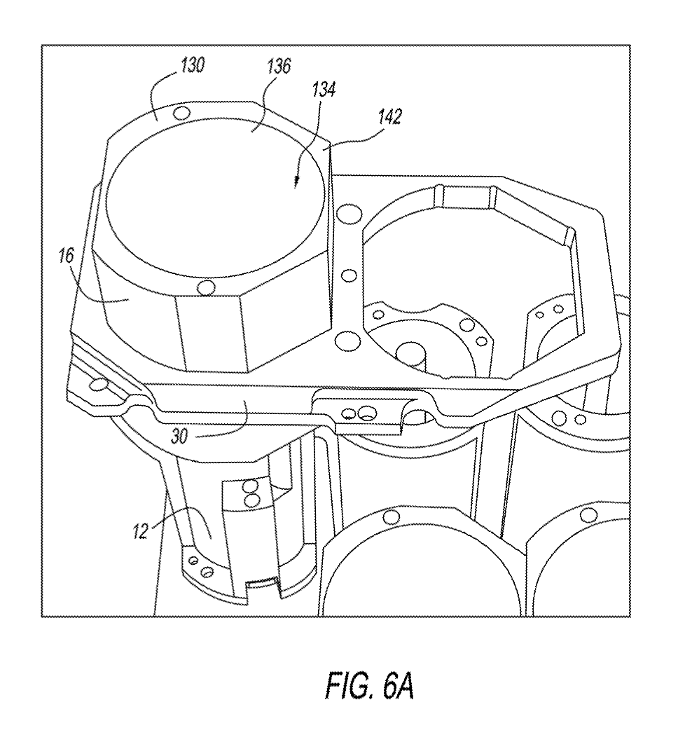

Turning now to the figures, it will be noted that the large modular alignment cylinder 16 (shown in FIGS. 4A-6A) of the present invention has a first or proximal end and a generally cylindrical interior passageway. The radially outwardly facing exterior surface of the large modular alignment cylinder has several flats, that are positioned so that the alignment cylinder 16 can be positioned appropriately within the molding machine.

In this application, the “proximal end” of the alignment cylinder 16 will refer to the end that is fixedly coupled to and disposed adjacent to the distal end of the plunger cylinder 12. The alignment cylinder 16 has a radially inwardly extending flange 126 at the proximal end. A variety of bolt receiving apertures pass through the radially inwardly extending flange, through which one or more bolts (not shown) can pass for coupling the large alignment cylinder 16 to the plunger cylinder 12. It will be appreciated that the flange extends radially Inwardly since alignment cylinder 16 has a diameter (width) that is greater than that of the plunger 12. This difference in width is best appreciated with referenced to FIG. 5e.

The flange also includes a “D” shape cut out portion 128. The D-shaped cut out portion 128 is sized and positioned for receiving an exhaust tube. It is highly desirable to keep the mold member 32 or 33 cool during the mold process. In order to keep the mold member 32 or 33 cool, air is flowed through the air tube 36 within the plunger cylinder 12, and the piston 34 to which the mold member 32 is mounted. This air is conducted from an outside air source to the mold member 32 to keep it cool.

Air that is introduced into the mold member 32 or 33, is exhausted front the mold member 32 or 33 through a series of exhaust apertures that are found in the mold member 32 or 33. Examples of male mold members with such mold apertures, are discussed in the Applicant's earlier patent, Keith Covert, U.S. Pat. No. 9,052,047 that issued on 9 Jun. 2015. The Covert '047 patent is fully incorporated into this application by reference and is made a part of this application.

The exhausted air then flows through the large modular alignment cylinder 16, and out through an exhaust tube (not shown), that is inserted into the D-shaped cut 128 in the radially inwardly extending flange 126. The exhausted air can then fee vented to a location outside of the mold.

There is little that the Applicant can do to change the size of the base 40 as the size of the base is governed by the size of the molding machine. Since the particular machine governs the size of the base, and since the size of the base limits the size of the plunger cylinder 12, the size of the plunger cylinder cannot be expanded to accommodate rather larger diameter male mold members, e.g. 33. Therefore, in order to accommodate larger diameter male mold members, the Applicant surprisingly discovered that the only way to do so effectively was to increase the diameter of the large modular alignment cylinder 16, that was not so constrained by base size.

Although the large modular alignment cylinder 16 can have one of a variety of diameters, the Applicant has found that the preferred modular alignment cylinder 16 has a diameter (width) of approximately 5.17 inches. If the modular alignment cylinder 16 were to get much larger than this, the size of the cylinder 12 might interfere with other parts of the mold machine. In FIG. 8B, there is also shown a long socket wrench extension 148 that is used to tighten and loosen the bolts that couple the plunger cylinder 12 to the base 40.

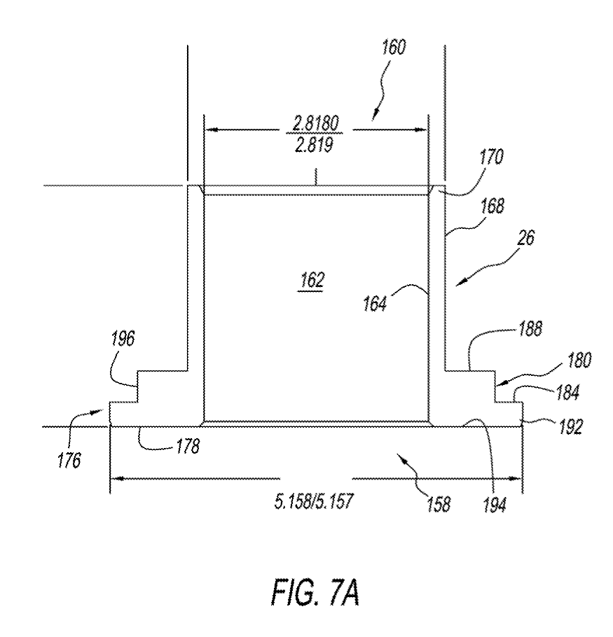

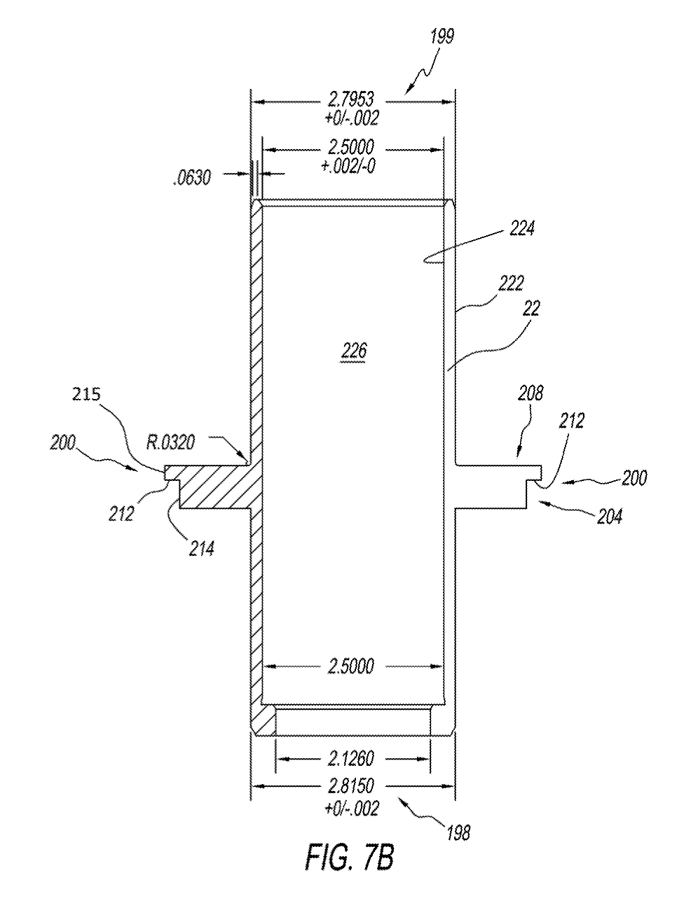

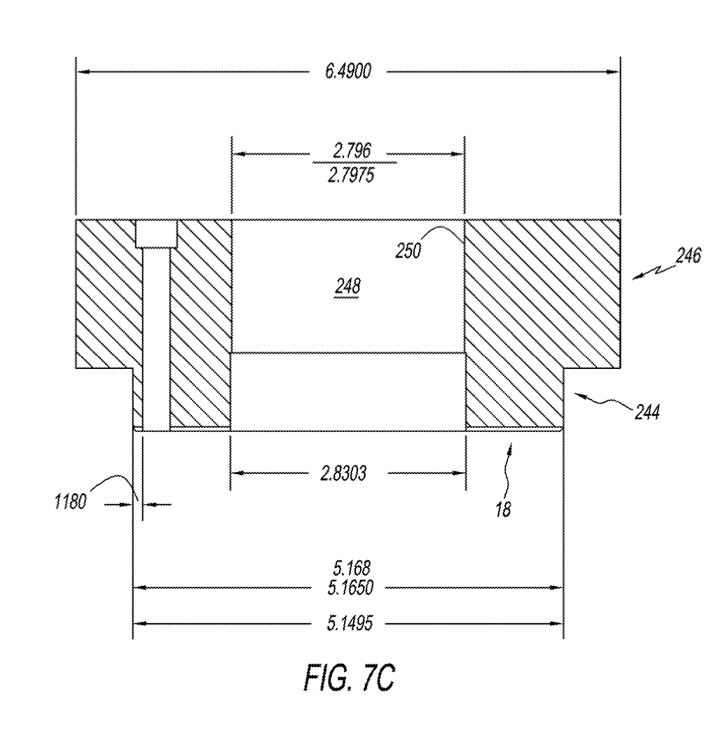

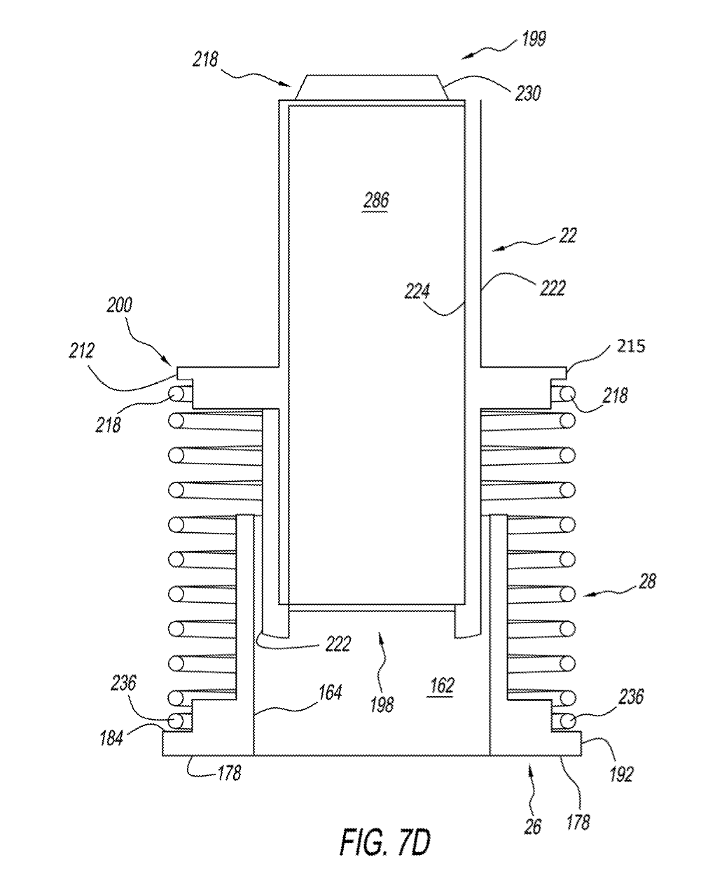

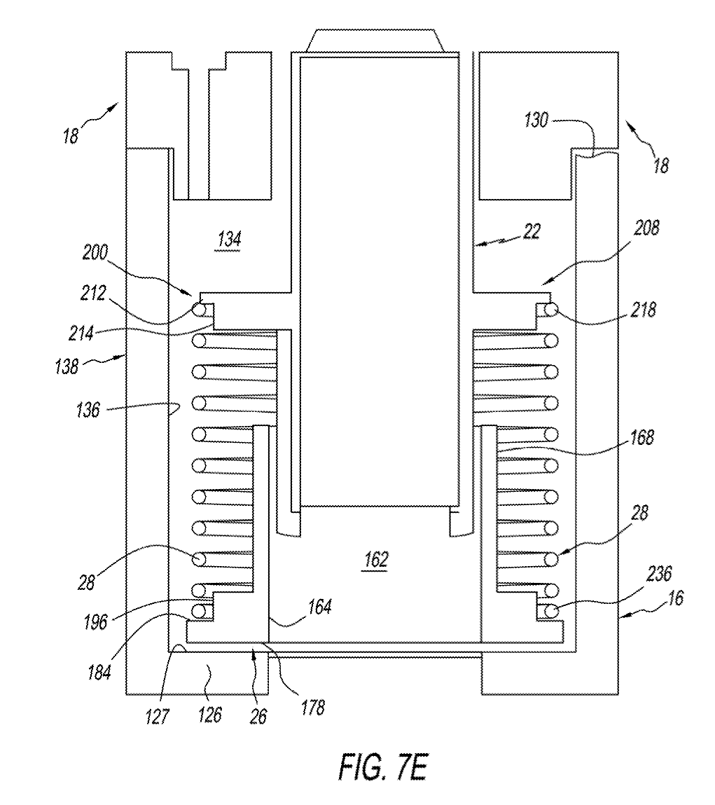

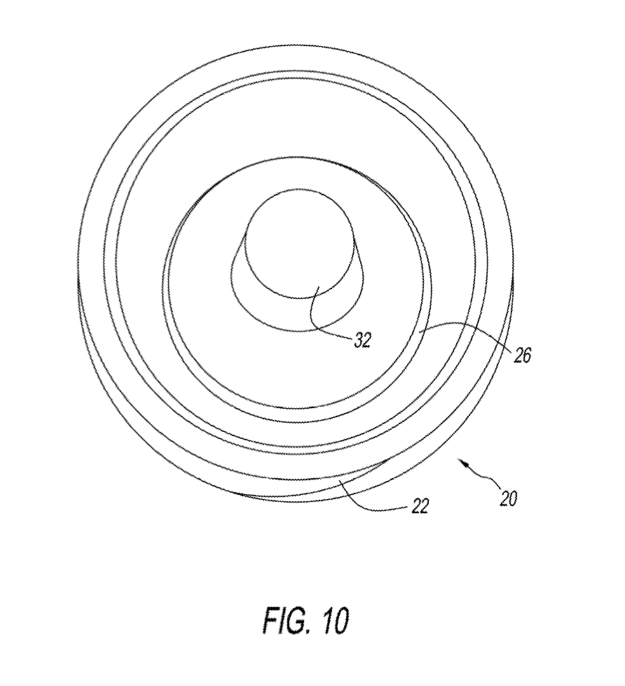

The alignment sleeve assembly 20 (FIGS. 5A, 7A-7E, and 9A-11D) includes the upper modular alignment sleeve 22, and the lower guide member 26, along with the top alignment modular sleeve collar 18, and compression spring 28, that are best shown in FIGS. 7A-7E. Because of the nature of the operations being performed by the sleeve assembly 20, the sleeve assembly and components must, such as upper modular alignment sleeve 22 and the lower guide modular sleeve 26 must have walls that are thick enough to be strong enough to operate over a long life cycle, without breaking down due to fatigue.

Turning first to the lower guide member 26, it will be noted that the lower guide member includes proximal end 158 and a distal end 160. As is used throughout this application, the proximal end 158 relates to that ends of the alignment sleeve 20 (and other components) that are disposed closest to the plunger cylinder 12 and base 40, and the distal end (here 160) refers to the that and that is furthest removed from the plunger cylinder 12 and base 40.

The lower guide member 26 includes a central passageway 162 that is open at both ends, and extends between the proximal end 158 and the distal end 160. A cylindrical wall 164 defines the cylindrical passageway 162. The cylindrical inner wall 164 includes the corresponding cylindrical outer wall 168 that is disposed on the other side of the cylinder, and a planar annular edge 170.

A radially outwardly extending flange 174 is disposed at the proximal end 158. As the radially outwardly extending flange extends outwardly, the radially outwardly flange 174 comprises a relatively enlarged diameter portion of the guide member, and the portion of the guide member 126 that includes cylindrical wall 168 comprises a relatively reduced diameter portion.

The inner diameter of the passageway 162, as defined by cylindrical inner wall 164 should have a diameter great enough to interiorly receive the radially outwardly facing cylindrical wail 222 of the modular sleeve 22, (FIG. 7D) as the proximal end 198 of the sleeve 22 is received within the passageway 162 of the lower guide member 26.

The radially outwardly extending flange 173 includes a proximal, enlarged diameter step 176 and a more distally disposed, relatively reduced diameter step 180. The first or most proximal step 176 includes a planar underside annular surface 178 that serves as a base for the guide member 26. The flange 173 also includes a first, axially distally facing step 184, which serves as a proximal spring seat for the compression spring 28, as best shown in FIG. 7E. A radially outwardly facing surface 196 cooperates with shelf surface 184 for helping to constrain the spring 28 and retain the spring 28 on the spring seat surface 184.

The second or more distally disposed shelf also includes an axially distally facing surface 188.

The first shelf 176 also includes a radially outwardly lacing surface 192, which represents the most radially outwardly disposed point of the cylinder guide member 26. The radially outwardly facing surface 192 is sized to have a diameter slightly smaller than the diameter of the interior cylindrical wall 136 of tire enlarged mold member 16, so that the guide member 26 will be interiorly received within the interior passageway 134 of the enlarged diameter alignment cylinder 16. It will be appreciated, that the diameter of the cylindrical wall 164 can be varied to receive modular sleeves 22 having varying outside diameters.

As shown in FIG. 7E, the planar underside annular surface 178 is sized, positioned, and configured to be received by the axially distally faced surface 127 of the radially inwardly mating flange 126 of the enlarged diameter alignment cylinder 16.

The upper modular alignment sleeve 22 includes a radially outwardly extending flange 200 mounted near its center, and the lower end guide member 26 also includes a radially outwardly extending flange that is disposed at the proximal end thereof. The radially outwardly extending flange of the lower guide member 26 is sized and positioned so that its generally planar axially proximally facing surface 178 can rest on the axially outwardly facing radially inwardly extending flange of the large modular alignment cylinder 16.

The radially outwardly facing surface 192 of the flange 180 of the lower guide member 26 is sized and positioned to be slightly smaller than the radially inwardly facing surface of the large modular alignment cylinder 16, so that the guide member 26 can be received interiorly within the axially extending passageway of the large modular alignment cylinder 16. The proximal surface 178 of the lower flange 180 of the lower guide member 26 is generally planar, so that it can engage and rest upon the upper surface 127 of the radially inwardly extending, lower flange 126 of the large modular alignment cylinder 16.

The flange 180 also includes a raised, annular bench 196 that is disposed radially inwardly, and a relatively more proximal, larger, axially distally facing portion of the lower guide member 26. The relatively radially outwardly disposed and axially distally facing surface 184 of the larger diameter portion serves as a spring seat 184 for receiving the proximal end 236 of the spring 28.

The base 236 of the spring 28 rests upon the surface 184 of the flange 180, and the radially outwardly facing side surface 196 of the bench portion helps to appropriately position the proximal 236 end of the spring 28 on the axially distally facing surface 184 of the enlarged diameter portion of the flange 180 of the lower guide member 26. It will be noted that the compression spring 28 extends between an upper spring rest 212 on a radially extending flange 200 of the upper modular alignment sleeve 22, and an axially durably facing spring seat surface 184 that is formed on a radially outwardly extending lower base flange 180 of the lower guide member 26. It further being noted that the spring 28 is a compression spring that is designed to move the upper modular alignment sleeve 22 in an axial direction, durably away from the base 180 of the lower guide member 26;

As best shown in FIGS. 7D, 7E and 9D and 11A, the upper modular alignment sleeve 22 includes a radially outwardly extending flange 200 that is disposed generally midway between the proximal 198 and distal 199 ends of the upper modular alignment sleeve.

The axially proximally facing surface of the flange 200 includes a reduced diameter thickened portion 204, and an enlarged diameter relatively distally disposed portion 208 (FIG. 7B). The reduced diameter portion 204 serves as something of a bench portion. The enlarged diameter 208 portion has a radially outwardly facing surface 215. The Enlarged Diameter portion also has an axially proximally facing surface 212 that serves as a seat for the upper end 218 of the spring 28, with the radially outwardly facing surface 214 of the bench portion serving as a means for aligning the spring 28 on the flange 200, and properly positioning the spring 28 on the flange 200.

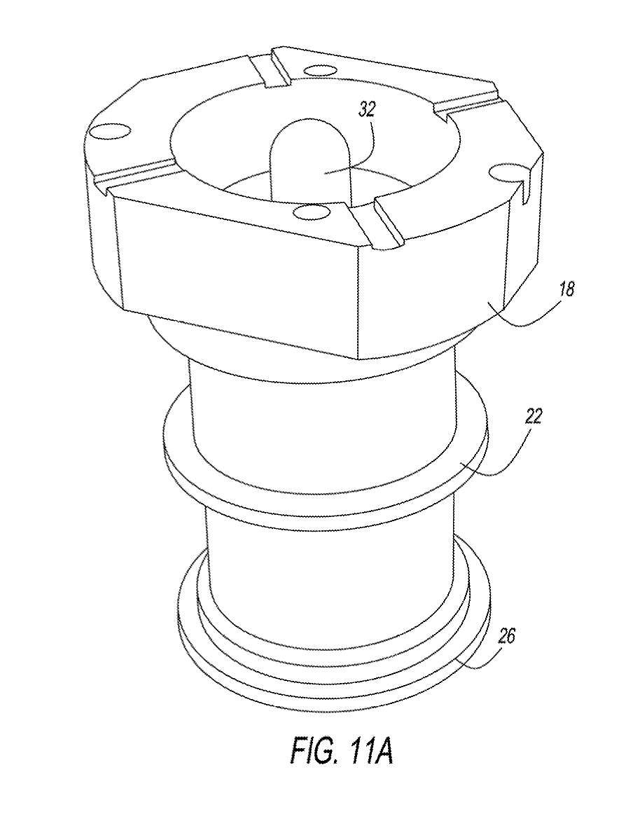

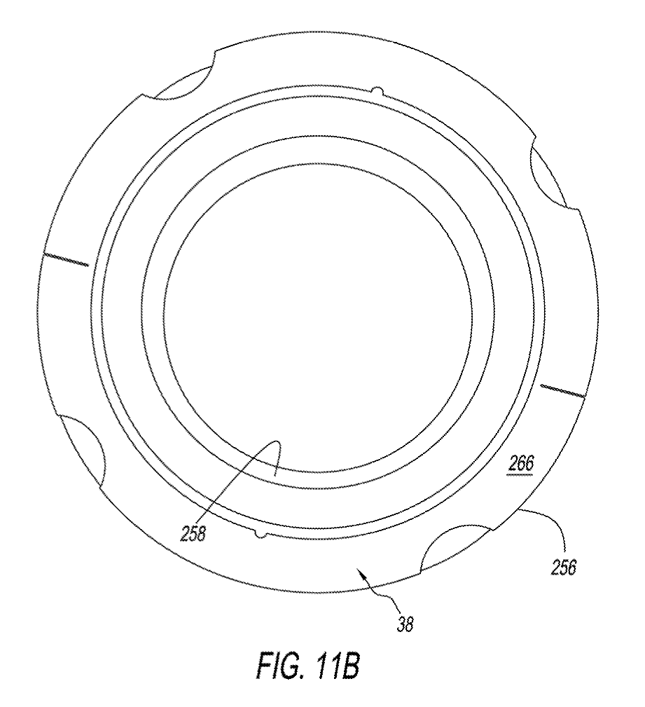

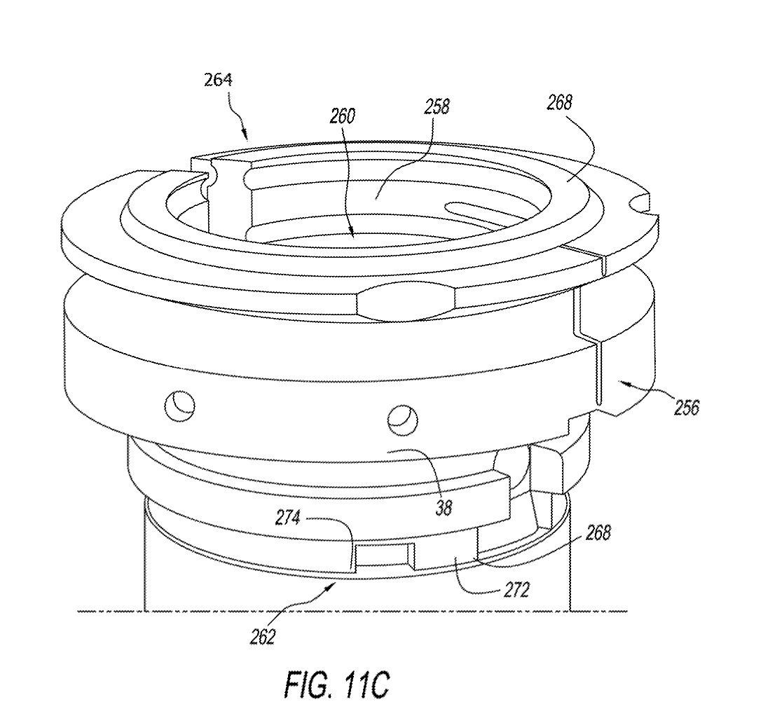

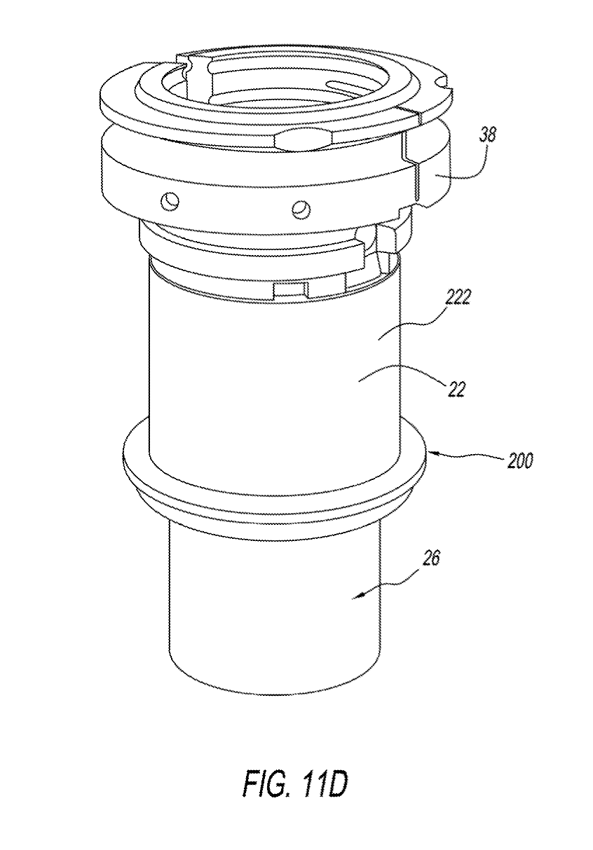

FIGS. 7C and 11A show that the top alignment modular sleeve collar 18 includes a reduced diameter portion 244 that can be interiorly received within the interior passageway of the large modular alignment cylinder 16, and a distally disposed large diameter portion 246 that has a diameter that is generally equal to the outer diameter of the large modular alignment cylinder 16, so that the top alignment modular sleeve collar 18 can be coupled to the large modular alignment cylinder 16. The collar 18 also includes a central passageway 248 defined by cylindrical wall 250 that is sized and positioned for interiorly receiving the distal portion of the upper modular alignment sleeve 22.

The diameter of the passageway 248 of the collar 18 should be slightly greater than the outer diameter of the upper modular alignment sleeve 22, so that the upper modular alignment sleeve 22 is slidably received within the interior passageway 248 of the top alignment modular sleeve collar 18. By so doing, the top alignment modular sleeve collar will be appropriately positioned with the neck ring 38. Additionally, the upper modular alignment sleeve 22, aligns the mold member 32, that, is the primary point of the alignment performed by the device.

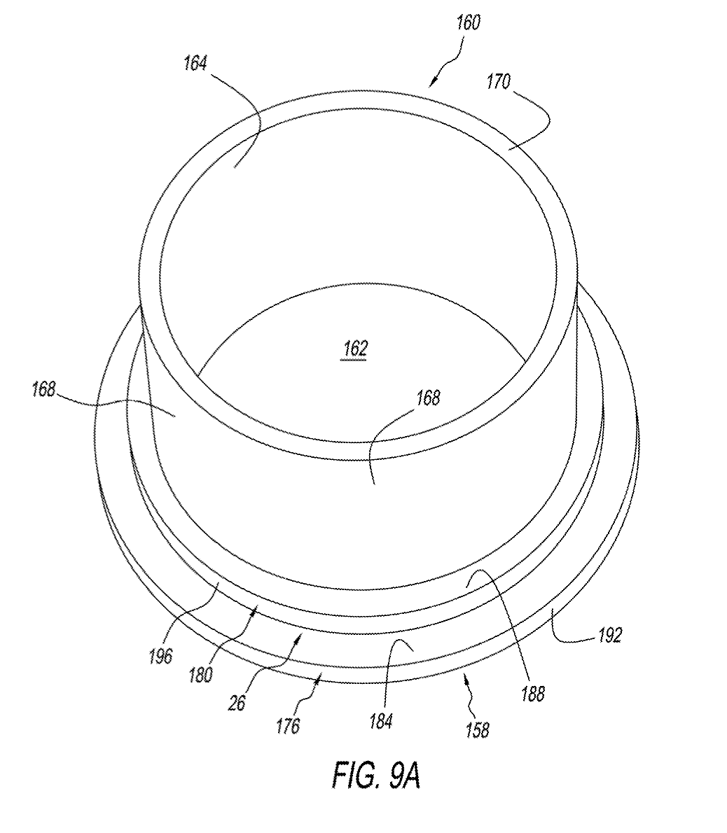

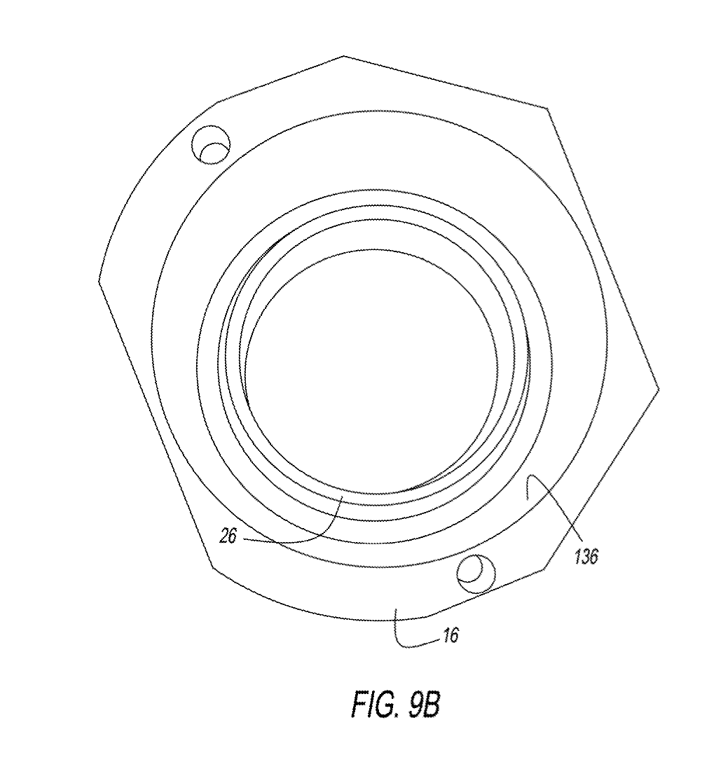

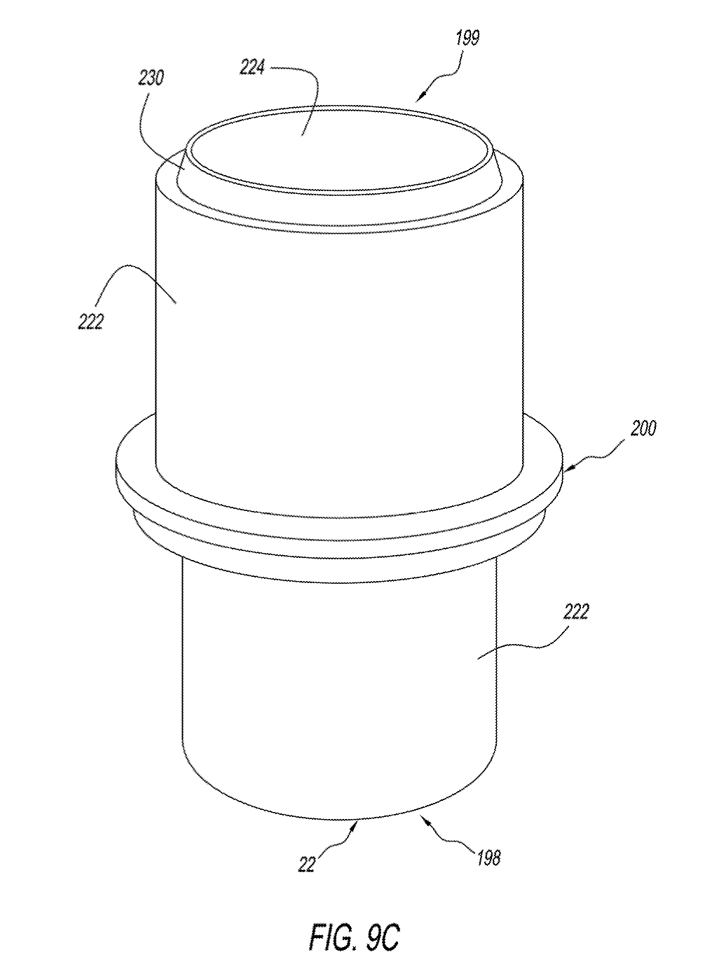

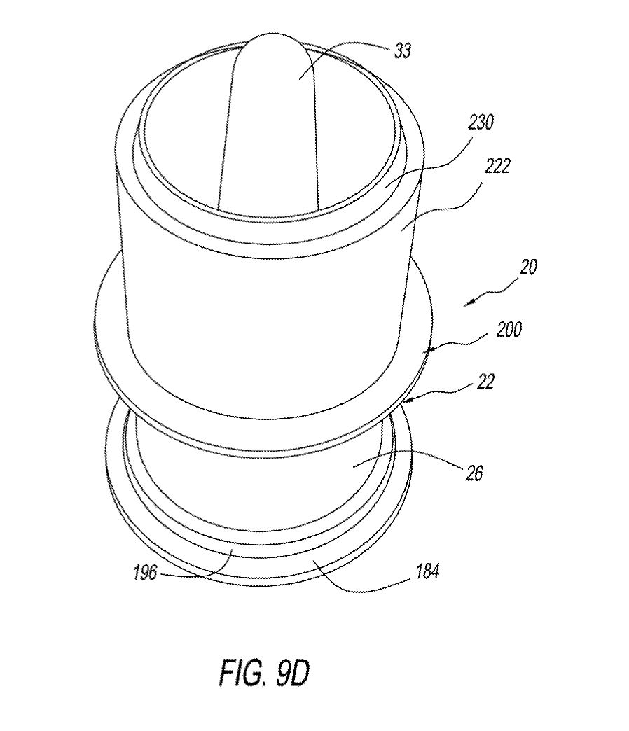

Turning now to FIG. 9C, it will be noted that the upper modular alignment sleeve 22, includes an upwardly extending, reduced diameter lip portion 218. The lip portion 218 has a beveled, radially outwardly facing surface 230, such that the diameter of the lip 218 is greater at its proximal portion, than it is at tire distal end of the lip 218.

The lip 218 comprises an alignment lip 218 that is designed to align with the neck ring 38. During the operation, the neck ring 38 and sleeve 22 will be separated and joined together.

It is highly desired that the neck ring 38 fit in the appropriate aligned position upon the sleeve 22, it is also highly desired that the neck ring 38 be able to engage and disengage with the sleeve 22 quite frequently and quite often, so that each time they engage and disengage the neck ring 38 is properly aligned on the sleeve 38, so that the mold member 32 can be approximately aligned with the female mold into which it will be inserted to form the axially extending cavity within the gob of molten glass to form a proper parison. The beveled surface 230 of the axially extending lip helps to enable the sleeve 22 easily receive and align with a corresponding beveled surface of the neck ring.

The neck ring 38 (FIGS. 5A, 11B, and 11e) is generally torus shaped and has a generally cylindrical radially outwardly facing surface 256 which defines the exterior, and a generally cylindrical radially inwardly facing surface 258 that defines an interior passageway 260 that is open at both ends and extends between the proximal end 262 and the distal end 264 of the ring 38. The ring 38 also includes a generally planar axially distally facing surface 268 and an axially proximal facing surface 266. The axially proximally facing surface 266 includes a plurality of modular sleeve 22 engaging feet 272. The feet 272 are include planar axially proximally facing end surfaces 274. The feet also include beveled radially inwardly facing surfaces that are sized, shaped, positioned and configured for interiorly receiving the radially outwardly facing beveled surface 230 of the lip 218 of the modular sleeve 22.

When the gob is placed on the first stage mold, the neck receiving member 38 forms the neck of the device. The neck receiving member 38, then moves with the formed gob of glass (parison) that contains the axially extending passageway formed by the male mold member, to the second stage of the mold. As discussed above, at the second stage of the mold, the neck ring 38 mates to the second stage and air is forced into the axially extending passageway within the parison to blow the bottle out to its appropriate size and shape as defined by the female mold of the second stage.

Having described the invention in detail with respect to certain preferred embodiments, it will be appreciated that variations and modifications exist within the scope and spirit of the present invention, and that the invention is only limited by the prior art and the claims.

What is claimed is:

1. A system for use in a glass container mold assembly that includes a base, a first plunger containing cylinder having a first cross sectional area configured and sized to fit upon the base, and a male mold member movable between a retracted and extended positioned that is configured for insertion into a gob of molten glass to form an interior cavity in the gob to form a parison capable of being blown into a glass container, the mold system comprising:
an alignment cylinder coaxially coupled to the plunger containing cylinder awl having a second cross-sectional area larger than the first cross-sectional area of the plunger containing cylinder for accommodating and receiving a male mold member having a cross-sectional area too large to be accommodated by the first cross-sectional area of the plunger containing cylinder, the alignment cylinder including an interior passageway.

2. The mold system of claim 1 further comprising a sleeve member having an exterior surface and an interior surface, the exterior surface being sized and configured for being received within the interior passageway of the alignment cylinder and the interior surface defining an interior passageway sized for receiving the male mold member having a first cross-sectional area.

3. The mold system of claim 2 wherein the sleeve member comprises a first sleeve member and the male mold member comprises a first male mold member, further comprising a second sleeve member that is interchangeable for the first sleeve member in the first alignment cylinder, the second sleeve member having an exterior surface and an interior surface, the exterior surface of the second sleeve member being configured tar being received within the interior passageway of the alignment cylinder, and an tenor surface defining an interior passageway sized for receiving a second male mold member, the second male mold member having a second diameter different than the diameter of the first male mold number.

4. The mold system of claim 2 wherein the sleeve member includes a distal end, a proximal end, and a radially outwardly extending flange coupled to the exterior surface of the sleeve member and disposed between the proximal end and distal end, and extending between the interior surface of the mold alignment cylinder and the exterior surface of the sleeve member.

5. The mold system of claim 4 wherein the radially outwardly extending flange has an outer diameter sized to be smaller than the diameter of the interior passageway of the alignment cylinder to permit the sleeve member to be slidably received within the interior passageway of the alignment cylinder, the flange including a surface configured to serve as a spring seat.

6. The mold system of claim wherein the alignment cylinder includes proximal end, a distal end, and a radially inwardly extending flange disposed in the interior passageway at the proximal end of the alignment cylinder.

7. The mold system of claim 6 further comprising a guide member having a proximal end, a distal end, and exterior side surface and an interior side surface, the exterior side surface having a diameter sized to be received within the interior of the alignment cylinder and the interior side surface defining an interior passageway sized for interiorly receiving the sleeve member.

8. The mold system of claim 7, wherein the guide member includes a radially outwardly exterior flange extending between the exterior side surface of the guide member and the interior surface of the mold alignment cylinder, a radially outwardly extending flange of the guide member having an outer diameter smaller than the diameter of the interior wall of the alignment cylinder to permit the guide member to be slidably received in the interior passageway of the alignment cylinder.

9. The mold system of claim 8, wherein the radially outwardly extending flange of the grade member includes an axially proximally facing surface sized and configured for being received on the radially inwardly extending flange of the alignment cylinder, and an axially distally facing surface configured to serve as a spring seat.

10. The mold system of claim 8 further comprising a compression spring having a distal end coupled to the spring seat of the radially outwardly extending flange of the slide member, and a proximal end coupled to the spring seat of the radially outwardly extending flange of the guide member.

11. The mold system of claim 10 further comprising a sleeve collar coupled to the distal end of the alignment cylinder, the sleeve collar including an interior passageway.

12. The mold system of claim 11, wherein the interior passageway of the sleeve collar is disposed coaxially with the interior passageway of the alignment cylinder, and has a diameter sized for interiorly slidably receiving the slide member.

13. The mold system of claim 12, wherein the interior passageway of the slide member is sized to slidably receive the male mold member such that the male mold member remains aligned in its passage between its retracted position and its extended position.

14. The mold system of claim 1 further comprising a sleeve member having a distal end, a proximal end, an exterior surface, a radially extending flange sized and configured for being slidably received within the interior passageway of the alignment cylinder, and an interior surface defining an interior passageway extending generally between the proximal and distal end of the sleeve member.

15. The mold system of claim 14, wherein the interior passageway of the side member is sized to slidably receive the male mold member such that the male mold member remains aligned in its passage between the retracted position and its extended position.

16. The mold system of claim 1 further comprising a guide member having a proximal end, a distal end, an exterior surface sized for being slidably received in the interior passageway and an interior surface defining an interior passageway extending between the proximal end and the distal end, and wherein the alignment cylinder includes a radially inwardly extending flange for receiving the proximal end of the guide member.

17. The mold system of claim 16 further comprising a slide member having a proximal end, a distal end, an exterior surface sized and configured for being slidably received within the interior passageway of the guide member, and a compression spring having a distal end received by a spring seat formed on the slide member and a proximal end received by a proximal end spring seat.

18. The mold system of claim 17, wherein the exterior surface of the sleeve member includes a radially outwardly extending flange on which the distal spring seat is formed, and the guide member includes a radially outwardly extending flange on which the proximal spring seat is formed.

19. The mold system of claim 1 further comprising a sleeve member sized for being slidably received within the interior passageway of the alignment cylinder, and having an interior passageway sized for receiving the male mold member;
a guide member sized for being slidably received in the interior passageway of the alignment cylinder, and an interior passageway sized for interiorly slidably receiving the slide member, and
a compression spring having a proximal end coupled to the guide member and a distal end coupled to the slide member.

20. The mold system of claim 12 further comprising a sleeve collar coupled to the alignment cylinder, the sleeve collar including an interior passageway coaxially aligned with the interior passageway of the alignment cylinder.

21. The mold system of claim 1 further comprising a ring member having a proximal end and a distal end, and a sleeve member having a proximal end, a distal end and an exterior surface sized and configured tor being slidably received with the interior passageway of the alignment cylinder, wherein the proximal end of the ring member is configured for matingly engaging the distal end of the sleeve member.

22. The mold system of claim 1, wherein the proximal end of the ring member includes at least one beveled surface, and the distal end of the sleeve member includes at least one beveled surface sized, positioned, and configured to matingly engage at feast one beveled surface of the ring member.
